(19) United States
(12) Patent Application Publication
(10) Pub. No.: US 2010/0044292 A1
(43) Pub. Date: Feb. 25, 2010

(54) WATER PURIFICATION MODULE

(76) Inventor: Chung-Yen Tseng, Taichung Hsien (TW)

Correspondence Address: Chien-Hui Su, P. O. Box 70-121 Taichung, Taichung City, 40899, TW

(21) Appl. No.: 12/195,418

(22) Filed: Aug. 21, 2008

(51) Int. Cl. B01D 29/15; C02F 1/44

(52) U.S. Cl. 210/232; 210/440; 210/321.87

(57) ABSTRACT

A water purification module comprises a housing having a space longitudinally defined in the housing and extending to a top of the housing to define an opening. A purified water outlet path, a waste water outlet path and an intake path are respectively laterally defined in a lower end of the housing and respectively communicate with the space. A filter set is longitudinally received in the space form the opening. The filter set includes a hollow prior filter longitudinally received in the space, a hollow filter housing longitudinally received in the prior filter, and a hollow posterior filter longitudinally received in the filter housing. A cap is partially and complementally received in the opening for closing the housing.

### BACKGROUND OF THE INVENTION

1. Field of the Invention

The present invention relates to a water purification module, and more particularly to water purification having a filter set mounted therein.

2. Description of Related Art

A conventional reverse osmosis water fountain in accordance with the prior art includes components of a reverse osmosis membrane, pre-filters which are installed ahead of the reverse osmosis membrane, and an appropriate tank to store the purified water. The system includes a pump and associated pressure sensing device for increasing the pressure of the incoming non-processed water to the reverse osmosis filter, and a pipe to carry the concentrate water from the reverse osmosis filter to the incoming main water supply. The reverse osmosis filter is received in a hollow filter housing. The filter housing has an opening defined on the lower end thereof for installing the reverse osmosis filter received in the filter housing.

However, the whole equipment of the conventional reverse osmosis water fountain is always huge, additionally including water storage and cables for the water and power, it wastes place for storing. The conventional reverse osmosis water fountain is complicated and costs a lot such that a normal user is hard to replace the old filter or maintain the water fountain by himself. The opening of the filter housing is defined in the lower end of the filter housing such that the user should disassemble the filter housing piece by piece for replacing the reverse osmosis filter. Therefore, the water in the reverse osmosis filter and the filter housing always flow over and it wastes time to clean the water more than to disassemble the filter housing.

The present invention has arisen to mitigate and/or obviate the disadvantages of the conventional reverse osmosis water fountain.

### SUMMARY OF THE INVENTION

The main objective of the present invention is to provide an improved water purification module that has a structure independently adapting to a water fountain.

To achieve the objective, the water purification module in accordance with the present invention comprises a housing having a space longitudinally defined in the housing and extending to a top of the housing to define an opening. A purified water outlet path, a waste water outlet path and an intake path are respectively laterally defined in a lower end of the housing and respectively communicate with the space. A filter set is longitudinally received in the space form the opening and includes a hollow prior filter longitudinally received in the space from the opening, a filter housing longitudinally received in the prior filter, and a posterior filter longitudinally received in the filter housing. A cap is partially and complementally received in the opening for closing the housing.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a water purification module in accordance with the present invention;

FIG. 2 is an exploded perspective view of the water purification module in FIG. 1;

FIG. 3 is a top plan view of a recording plane of the water purification module in accordance with the present invention;

FIG. 4 is a bottom plan view of the purification module in FIG. 1;

FIG. 5 and FIG. 6 are operational views of the water purification module in accordance with the present invention;

FIG. 7 is a side cross-sectional view of the purification module of the present invention along line 7-7 in FIG. 4;

FIG. 8 is a side cross-sectional view of the purification module of the present invention along line 8-8 in FIG. 4; and

FIG. 9 is a side cross-sectional view of the purification module of the present invention along line 9-9 in FIG. 4.

### DETAILED DESCRIPTION OF THE INVENTION

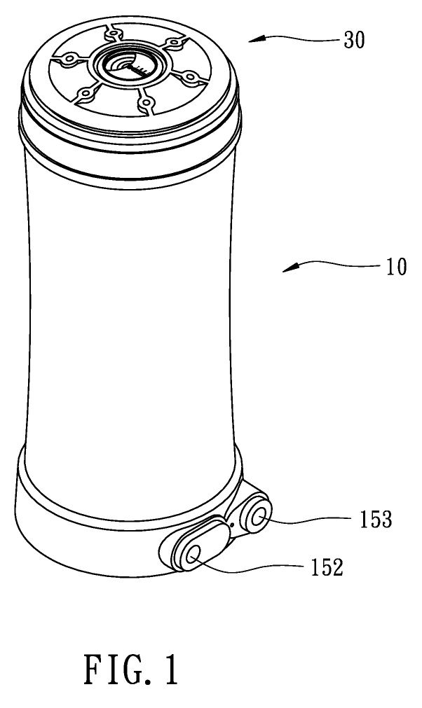

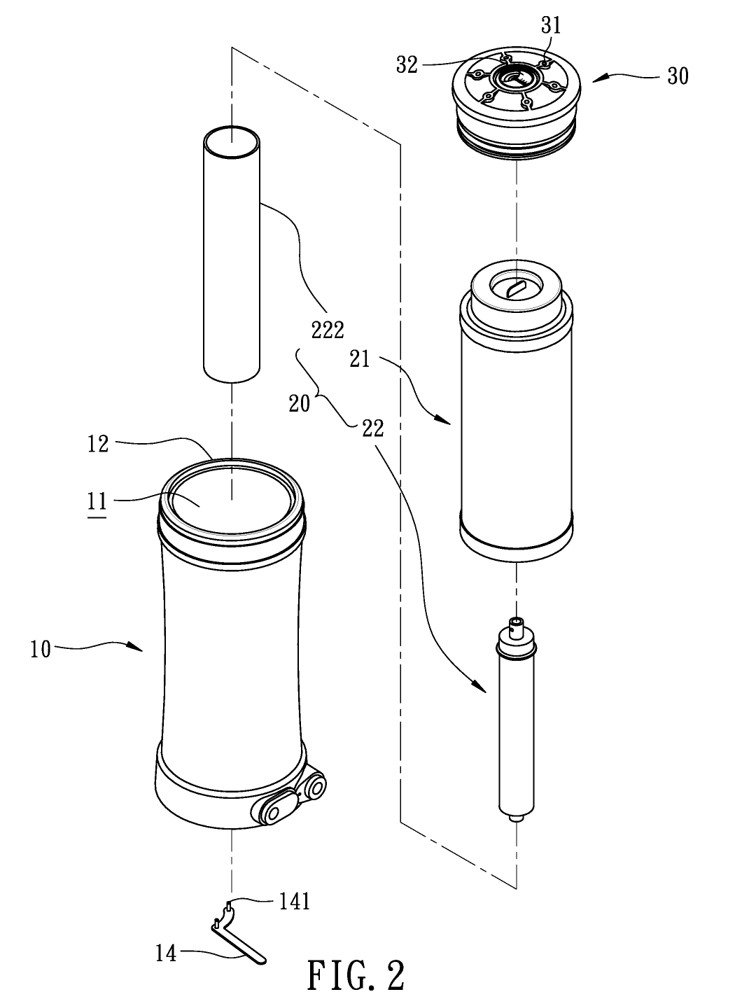

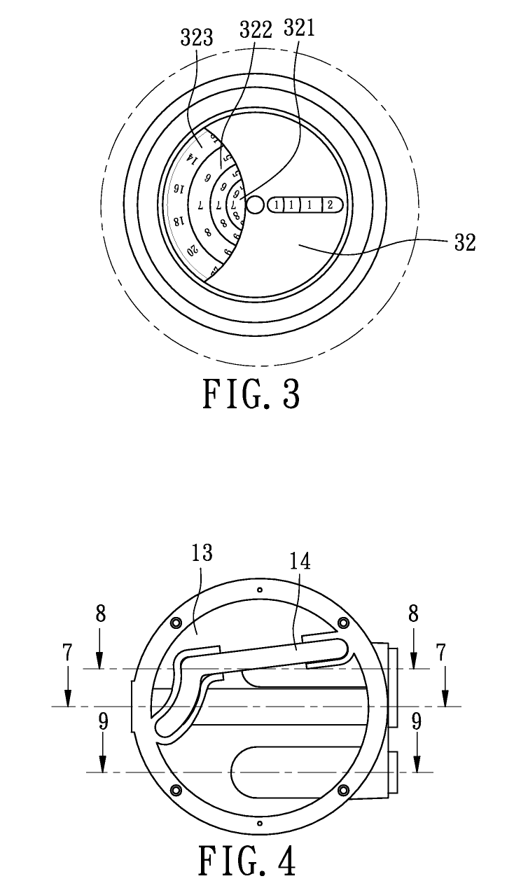

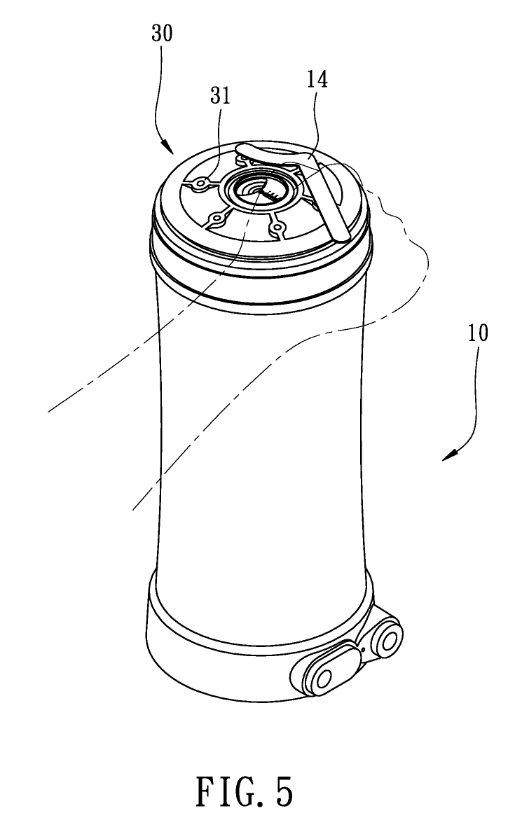

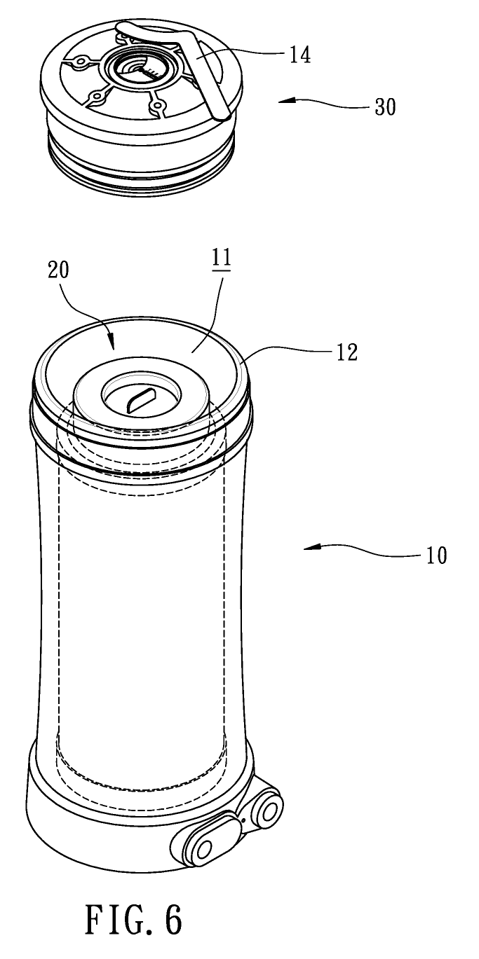

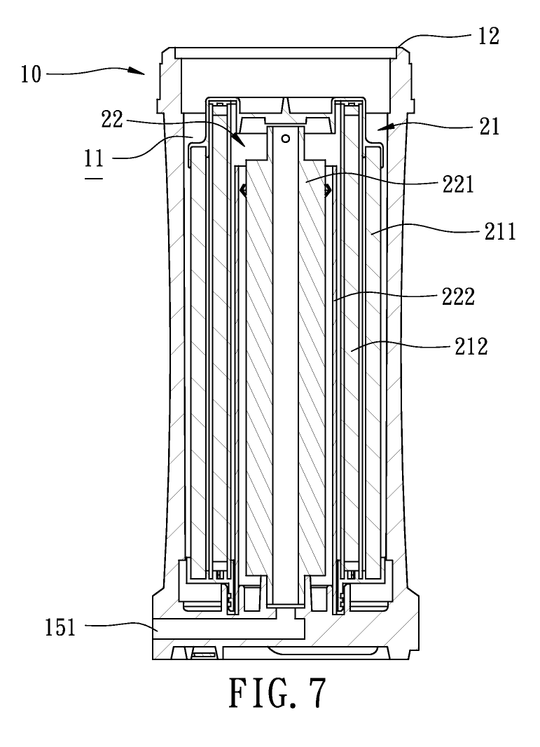

Referring to the drawings and initially to FIGS. 1-6, a water purification module in accordance with the present invention comprises a housing (10) having a space (11) longitudinally defined in the housing (10) and extending to a top of the housing (10) to define an opening (12). A fixing slot (13) is longitudinally defined in a lower end of the housing (10) and a wrench (14) is detachably received in the fixing slot (13). The wrench (14) has multiple stubs (141) extending therefrom. A purified water outlet path (151), as shown in FIG. 7, is laterally defined in a lower end of the housing (10) and communicates with the space (11). A waste water outlet path (152) and an intake path (153) are laterally defined in the lower end of the housing (10) opposite to the purified water outlet path (151) and communicate with the space (11).

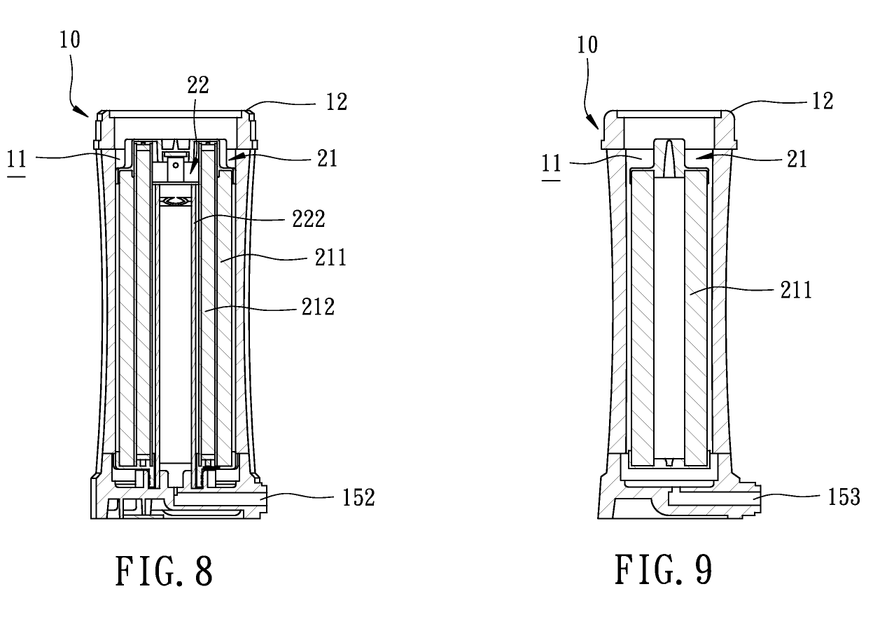

The purification module (1) has a filter set (20) longitudinally received in the space (11) from the opening (12). The filter set (20) includes a hollow prior filter (21), a hollow posterior filter (22) and a hollow filter housing (222). The posterior filter (22) is longitudinally received in the filter housing (222) and the filter housing (222) is longitudinally received in the prior filter (21) after receiving the posterior filter (22). Further with reference to FIGS. 7-9, the prior filter (21) longitudinally communicates with the intake path (153). The filter housing (222) longitudinally communicates with the waste water outlet path (152). The posterior filter (22) longitudinally communicates with the purified water outlet path (151). The prior filter (21) has a hollow first filter cartridge (211) mounted therein and a hollow second filter cartridge (212) mounted in the first filter cartridge (211) for purifying water. The posterior filter (22) has a hollow posterior filter cartridge (221) mounted in the posterior filter (22). In the preferred embodiment, the first filter cartridge (211) is a polypropylene fiber filter cartridge, the second filter cartridge (212) is an activated carbon fiber filter cartridge, and the posterior filter cartridge (221) is a reverse osmosis filter cartridge. The posterior filter (22) communicates with the purified water outlet path (151). Therefore, the opening (12) is defined in the upper end of the housing (10) such that the filter set (20) is easily taken out from the opening (12) for preventing the water in the filter set (20) and housing (10) from flowing over. A user may easily change or replace the filter set (20) by himself/herself.

The purification module (1) further comprises a cap (30) partially and complementally received in the opening (12) for closing the housing (10). The cap (30) has a recording plane (32) centrally disposed on an upper surface of the cap (30). The recording plane (32) has a first disk (321), a second disk (322), and a third disk (323) co-axially mounted in the recording plane (32). Each of the first disk (321), the second disk (322), and the third disk (323) has a series of scales concentrically disposed thereon for respectively showing a numeral of year, month, and day such that a user can read the numeral of the year from the first disk (321), the numeral of the month from the second disk (322) and the numeral of the day from the third disk (323) for recognizing last changing date of the filter set (20). The cap (30) has multiple holes (31) concentrically and radially defined in the upper surface of the cap (30) for receiving the stubs (141) of the wrench (14). In the preferred embodiment of the present invention, the quantity of the holes (31) is six and the six holes (31) are equidistantly and radially defined in the upper surface of the cap (30), and the quantity of the stubs (141) of the wrench (14) is two and the stubs (141) are selectively engaged to the holes (31) of the cap (30) for easily fastening/loosening the cap (30) received in the opening (12) to close/open the housing (10).

With reference to FIG. 7 to FIG. 9, the intake path (153) communicates with the prior filter (21) such that normal water is injected into the intake path (153). The prior filter (21) receives the normal water and purifies the normal water with the first filter cartridge (211) and the second filter cartridge (212). Than the purified water is received in the posterior filter (22) and purified again by the posterior filter cartridge (221) to separate into purified water and wasted water. The purified water is discharged from a center of the hollow posterior filter cartridge (221) to the purified water outlet path (151) for providing a clean purified water. The wasted water is discharged from an outer periphery of the posterior filter (22) to the waste water outlet path (152).

Although the invention has been explained in relation to its preferred embodiment, it is to be understood that many other possible modifications and variations can be made without departing from the spirit and scope of the invention as hereinafter claimed.

What is claimed is:

1. A water purification module comprising:
a housing having a space longitudinally defined therein and extending to a top of the housing to define an opening, a purified water outlet path, a waste water outlet path and an intake path respectively laterally defined in a lower end of the housing and respectively communicating with the space;
a filter set longitudinally received in the space form the opening, the filter set including a hollow prior filter longitudinally received in the space, a hollow filter housing longitudinally received in the prior filter, and a hollow posterior filter longitudinally received in the filter housing; and
a cap partially and complementally received in the opening for closing the housing.

2. The water purification module as claimed in claim 1, wherein the lower end of the housing having a fixing slot longitudinally defined therein, a wrench detachably received in the fixing slot, the wrench having multiple stubs extending therefrom, the cap having multiple holes concentrically and radially defined in an upper surface of the cap for receiving the stubs of the wrench;
whereby, the stubs of the wrench are selectively engaged to the holes of the cap for rotatably engaging to the cap and selectively closing the housing.

3. The water purification module as claimed in claim 1, wherein the cap has a recording plane centrally disposed on an upper surface of the cap.

4. The water purification module as claimed in claim 3, wherein the recording plane has a first disk, a second disk, and a third disk co-axially mounted in the recording plane, each of the first disk, the second disk, and the third disk having a series of scales concentrically disposed thereon for respectively showing a numeral of year, month, and day;
whereby, a user reads the numeral of the year from the first disk, the numeral of the month from the second disk and the numeral of the day from the third disk for recognizing last changing date.

5. The water purification module as claimed in claim 2, wherein the cap has a recording plane centrally disposed on the upper surface of the cap.

6. The water purification module as claimed in claim 5, wherein the recording plane has a first disk, a second disk, and a third disk co-axially mounted in the recording plane, each of the first disk, the second disk, and the third disk having a series of scales concentrically disposed thereon for respectively showing a numeral of year, month, and day;
whereby, a user reads the numeral of the year from the first disk, the numeral of the month from the second disk and the numeral of the day from the third disk for recognizing last changing date.

7. The water purification module as claimed in claim 1, wherein the prior filter has a hollow first filter cartridge mounted therein and a hollow second filter cartridge mounted in the first filter cartridge, the posterior filter having a hollow posterior filter cartridge mounted in the posterior filter.

8. The water purification module as claimed in claim 7, wherein the first filter cartridge is a polypropylene fiber filter cartridge, the second filter cartridge is an activated carbon fiber filter cartridge, and the posterior filter cartridge is a reverse osmosis filter cartridge.

9. The water purification module as claimed in claim 2, wherein the prior filter has a hollow first filter cartridge mounted therein and a hollow second filter cartridge mounted in the first filter cartridge, the posterior filter having a hollow posterior filter cartridge mounted in the posterior filter.

10. The water purification module as claimed in claim 9, wherein the first filter cartridge is a polypropylene fiber filter cartridge, the second filter cartridge is an activated carbon fiber filter cartridge, and the posterior filter cartridge is a reverse osmosis filter cartridge.

11. The water purification module as claimed in claim 3, wherein the prior filter has a hollow first filter cartridge mounted therein and a hollow second filter cartridge mounted in the first filter cartridge, the posterior filter having a hollow posterior filter cartridge mounted in the posterior filter.

12. The water purification module as claimed in claim 11, wherein the first filter cartridge is a polypropylene fiber filter cartridge, the second filter cartridge is an activated carbon fiber filter cartridge, and the posterior filter cartridge is a reverse osmosis filter cartridge.

13. The water purification module as claimed in claim 4, wherein the prior filter has a hollow first filter cartridge mounted therein and a hollow second filter cartridge mounted in the first filter cartridge, the posterior filter having a hollow posterior filter cartridge mounted in the posterior filter.

14. The water purification module as claimed in claim 13, wherein the first filter cartridge is a polypropylene fiber filter cartridge, the second filter cartridge is an activated carbon fiber filter cartridge, and the posterior filter cartridge is a reverse osmosis filter cartridge.

15. The water purification module as claimed in claim 5, wherein the prior filter has a hollow first filter cartridge mounted therein and a hollow second filter cartridge mounted in the first filter cartridge, the posterior filter having a hollow posterior filter cartridge mounted in the posterior filter.

16. The water purification module as claimed in claim 15, wherein the first filter cartridge is a polypropylene fiber filter cartridge, the second filter cartridge is an activated carbon fiber filter cartridge, and the posterior filter cartridge is a reverse osmosis filter cartridge.

17. The water purification module as claimed in claim 6, wherein the prior filter has a hollow first filter cartridge mounted therein and a hollow second filter cartridge mounted in the first filter cartridge, the posterior filter having a hollow posterior filter cartridge mounted in the posterior filter.

18. The water purification module as claimed in claim 17, wherein the first filter cartridge is a polypropylene fiber filter cartridge, the second filter cartridge is an activated carbon fiber filter cartridge, and the posterior filter cartridge is a reverse osmosis filter cartridge.

19. A water purification module comprising:
a housing having a space longitudinally defined therein and extending to a top of the housing to define an opening, a purified water outlet path, a waste water outlet path and an intake path respectively laterally defined in a lower end of the housing and respectively communicating with the space;
a filter set longitudinally received in the space form the opening, the filter set including a hollow prior filter longitudinally received in the space, a hollow filter housing longitudinally received in the prior filter, and a hollow posterior filter longitudinally received in the filter housing; and
a cap partially and complementally received in the opening for closing the housing.
